(19) United States
(12) Patent Application Publication
(10) Pub. No.: US 2013/0305527 A1
(43) Pub. Date: Nov. 21, 2013

(54) Joint Connector Unit

(71) Applicant: Tomohiko Shimizu, Makinohara-shi (JP)

(72) Inventor: Tomohiko Shimizu, Makinohara-shi (JP)

(73) Assignee: YAZAKI CORPORATION, Minato-ku, Tokyo (JP)

(21) Appl. No.: 13/982,907

(22) PCT Filed: Feb. 9, 2012
(86) PCT No.: PCT/JP2012/053006

§ 371 Date: Jul. 31, 2013

(30) Foreign Application Priority Data
Feb. 15, 2011 (JP) 2011-030099

(51) Int. Cl. H01R 43/20

(52) U.S. Cl. CPC H01R 43/20
USPC 29/747

(57) ABSTRACT

When a terminal attachment jig 41 is attached to a connector housing 30 before female terminal fittings 20 are inserted into female terminal accommodation holes 34 arrayed at another end of the connector housing 30, jig bodies 41a of the terminal attachment jig 41 to be inserted into respective jig insert holes 38 deform and deflect respective lances 36 of the connector housing 30 such that the lances move away from corresponding female terminal accommodation holes 34. When the female terminal fittings 20 has reached the specified position, the jig bodies 41a are disengaged from the respective lances 36 by interference between parts on the respective pieces of female terminal fittings 20 and the terminal attachment jig, whereby the lances 36 are returned to a state where they retain the respective pieces of female terminal fittings 20.

### TECHNICAL FIELD

The present invention relates to a joint connector unit that conductively interconnects a plurality of pieces of female terminal fittings by means of a joint terminal.

### BACKGROUND ART

FIG. 8 shows an example of a related an joint connector.

A joint connector 100 is described in connection with Patent Document 1 to be described below and has a joint terminal (bus bar) 110, a plurality of pieces of female terminal fittings 120, a first connector housing 130, and a second connector housing 140.

The joint terminal 110 has a plurality of tab pieces 111 that are articles formed from a metal plate by pressing and are to be fit-connected to the respective pieces of female terminal fittings 120 and a joining section 112 which conductively interconnects the tab pieces 111.

The female terminal fittings 120 have angular-tube-like boxes 121 that are articles formed from a metal plate by pressing and into which the respective tab pieces 111 are to be fitted, cable caulking sections 122 that extend out of rear ends of the respective boxes 121 and that crimp respective electric cables 150, and engagement recesses 123 for retaining purposes.

The first connector housing 130 has one housing end part 131 that is an article formed from a resin by injection molding and a tube-like hood 132 that extends out of the one housing end part 131.

The one housing end part 131 retains and accommodates the joint terminal 110 while the tab pieces 111 are oriented toward the other housing end part 130a (at right of FIG. 8). The one housing end part 131 is formed by; for instance, insert molding, and retains the joint terminal 110.

The hood 132 is a tube-like section into which the second connector housing 140 is to be fitted. The hood 132 has lock holes 134 used for fastening the thus-fitted second connector housing 140.

The second connector housing 140 accommodates and retains the female terminal fittings 120 and is fit-connected to the first connector housing 130.

The second connector housing 140 has a plurality of female terminal accommodation holes 141 that accommodate the pieces of female terminal fittings 120, lances 142 that retain the pieces of female terminal fittings 120 inserted into the respective female terminal accommodation holes 141, and lock projections 143 that lock the second connector housing 140 jointed to the first connector housing 130.

In each of the lances 142, a terminal latch projection 142b that projects toward the corresponding female terminal accommodation hole 141 is placed at a free end of a resilient piece 142a which stretches along the female terminal accommodation hole 141. In each of the lances 142, during the course of the female terminal fittings 120 being inserted into the corresponding female terminal accommodation hole 141, the resilient piece 142a becomes resiliently deformed by means of interference between the box 121 of the female terminal fittings 120 and the corresponding terminal latch projection 142b in such a way that the terminal latch projection 142b becomes bent outside the female terminal accommodation hole 141, thereby permitting insertion of the female terminal fittings 120. When the pieces of the female terminal fittings 120 are inserted up to respective specified positions, the terminal latch projections 142b are engaged with the engagement recesses 123 of the respective pieces of the female terminal fittings 120 by dint of resilient restoring force of the respective terminal latch projections 142b, thereby retaining the respective pieces of the female terminal fittings 120.

When the first connector housing 130 and the second connector housing 140 have finished normally fitting together, the lock projections 143 are engaged with the respective lock holes 134 of the first connector housing 130, thereby locking the connector housings in a mutually joined state.

In the foregoing joint connector 100, a half fitted state detection projection 135 is provided on the one housing end part 131 of the first connector housing 130 as half fitted state detection means for detecting a half fitted state (an incomplete inserted state) in which the respective pieces of the female terminal fittings 120 provided on the second connector housing 140 have not yet reached their respective specified positions.

The half fitted state detection projection 135 is a projection that is inserted into a shelter space 145 of each of the lances 142 when the first connector housing 130 and the second connector housing 140 are fitted into each other. In a half fitted state in which the respective pieces of the female terminal fittings 120 are not fully fitted into the respective female terminal accommodation holes 141, the lances 142 are resiliently deformed toward the respective shelter spaces 145. Accordingly, when the housings are fitted into each other, the half fitted state detection projection 135 interferes with leading ends of the respective lances 142 that remain deformed toward the respective shelter spaces 145, thereby hindering mutual-fitting of the housings. The half fitted state of the female terminal fittings 120 is thereby detected.

### RELATED ART DOCUMENT

### Patent Document

Patent Document 1: JP-A-8-250185

### SUMMARY OF THE INVENTION

### Problem That the Invention is to Solve

In the joint connector 100 described in connection with Patent Document 1, however, the first connector housing 130 that accommodates and retains the joint terminal 110 and the second connector housing 140 that accommodates and retains the female terminal fittings 120 are separated from each other, which raises a problem of an increase in the number of components.

Moreover, a process for fit-connecting the first connector housing 130 to the second connector housing 140 is necessary to fit-connect the joint terminal 110 to the female terminal fittings 120, which adds to the number of assembly processes. For this reason, there also arises a problem of difficulty being encountered in enhancing ease of assembly.

Moreover, the lances 142 that retain the second connector housing 140 cause resistance when the female terminal fittings 120 is inserted into the second connector housing 140. Therefore, there is also a problem of time and effort being consumed by attachment of the female terminal fittings 120.

Further, the half fitted state detection projection 135 is formed on the joint terminal 110 as means for detecting a half fitted state of the female terminal fittings 120. Consequently, another problem is that the structure of the first connector housing 130 is complicated by provision of the half fitted state detection projection 135.

Accordingly, an objective of the present invention is to solve the problem and to provide a joint connector unit that enables a reduction in number of components and an improvement in ease of assembly.

### Means for Solving the Problem

The objective of the present invention is attained by the following configurations.

(1) A joint connector unit comprising:

a plurality of pieces of female terminal fittings;

a joint terminal having a plurality of tab pieces for fit-connecting the pieces of female terminal fittings and a joining section for conductively connecting the tab pieces;

a plastic connector housing having one housing end part that accommodates and retains the joint terminal while the tab pieces are oriented toward another housing end part, the other hosing end that has arrayed female terminal accommodation holes for fittings the tab pieces into the respective pieces of female terminal fittings as a result of the pieces of female terminal fittings being inserted up to a specified position, lances that have resilient pieces stretching along the female terminal accommodation holes and terminal latching projections projecting from free ends of the respective resilient pieces toward the corresponding female terminal accommodation holes and that retain the pieces of female terminal fittings inserted to the specified position by means of the terminal latching projections, and a plurality of jig insert holes penetratingly opened in an exterior housing wall such that free ends of the respective lances are externally laid open; and

a terminal attachment jig that causes jig bodies inserted into the respective jig insert holes to latch on the free ends of the respective lances when attached to the connector housing before insertion of the female terminal fittings and that deflects and deforms the lances such that the terminal latching projections move away from the respective female terminal accommodation holes and that unlatches the jig bodies from the lances by interference between parts on the respective pieces of female terminal fittings and the terminal attachment jig when the respective pieces of female terminal fittings have reached the specified position, thereby returning the lances to a state where the lances retain the female terminal fittings.

(2) In the joint connector unit described in connection with (1), the respective pieces of female terminal fittings have insert guide projections that stretch along a direction of insertion into the respective female terminal accommodation holes;

the connector housing has guide grooves that slidably accommodate the insert guide projections during insertion of the pieces of female terminal fittings into the female terminal accommodation holes, to thus guide the pieces of female terminal fittings to the specified position; and

the insert guide projections collide against the jig bodies when the pieces of female terminal fittings have reached the specified position, thereby unlatching the jig bodies from the lances.

In the configuration (1), a fit connection between the joint terminal and the female terminal fittings is implemented by means of the single connector housing that accommodates and retains at one end the joint terminal and that receives at the other end the female terminal fittings being inserted. Therefore, when compared with the related art joint connector made by fit-connection of a pair of connector housings, the number of components can be curtailed.

Retaining the female terminal fittings in the connector housing is realized by means of the engagement between the lances provided in the connector housing and the female terminal fittings. However, in the course of the pieces of female terminal fittings being inserted into the respective terminal accommodation holes, the lances are moved away from the female terminal accommodation holes by the terminal attachment jig.

Accordingly, during the female terminal fittings being inserted into the connector housing, the female terminal fittings do not undergo resistance from the lances. Hence, operation for inserting the female terminal fittings is facilitated, so that ease of assembly can be enhanced.

In the configuration (2), when the female terminal fittings is inserted up to the specified position in the respective female terminal accommodation holes while the terminal attachment jig remains fitted to the connector housing, the insert guide projections outfitted to the respective pieces of female terminal fittings collide against the jig bodies of the terminal attachment jig, thereby bringing the jig bodies out of engagement with the lances.

Put another way, the jig bodies of the terminal attachment jig outfitted to the connector housing are held in engagement with the respective lances until the female terminal fittings reach the specified position in the respective female terminal accommodation holes. Therefore, it is possible to detect whether or not the female terminal fittings outfitted to the connector housing is in a half-fitted state according to whether or not the jig bodies are disengaged from the lances. Accordingly, a necessity for outfitting a custom-designed half-fitted state detection structure to the connector housing is obviated, and hence the structure of the connector housing can be simplified.

In the joint connector unit of the present invention, a fit connection between the joint terminal and the female terminal fittings is implemented by means of the single connector housing that accommodates and retains at one end the joint terminal and that receives at the other end the female terminal fittings being inserted. Therefore, when compared with the related art joint connector made by fit-connection of a pair of connector housings, the number of components can be curtailed.

Retaining the female terminal fittings in the connector housing is realized by the engagement between the lances provided in the connector housing with the female terminal fittings. However, in the course of the pieces of female terminal fittings being inserted into the respective female terminal accommodation holes, the lances are moved away from the female terminal accommodation holes by the terminal attachment jig.

Accordingly, during the female terminal fittings being inserted into the connector housing, the female terminal fittings do not undergo resistance from the lances. Hence, operation for inserting the female terminal fittings is facilitated, so that ease of assembly can be enhanced.

### BRIEF DESCRIPTION OF THE DRAWINGS

FIG. 1 is an exploded perspective view of an embodiment of a joint connector unit of the present invention.

FIG. 2 is a perspective view of a leading end of female terminal fittings shown in FIG. 1 acquired when it is viewed from a diagonally upper right position.

FIG. 3 is a perspective view of another end of a connector housing shown in FIG. 1 acquired when it is viewed from a diagonally lower left position.

FIG. 4 is a bottom view of the connector housing shown in FIG. 1.

FIG. 5 is a partially broken perspective view showing a structure of bottoms of female terminal accommodation holes of the connector housing shown in FIG. 1.

FIGS. 6(a) to FIG. 6(c) are explanatory views of processes through which a terminal attachment jig is inserted into a jig insert hole of the connector housing shown in FIG. 1.

FIG. 7(a) and FIG. 7(b) are explanatory views of processes through which the female terminal fittings are inserted into the respective female terminal accommodation holes of the connector housing shown in FIG. 1.

FIG. 8 is a longitudinal cross sectional view of an exploded state of a related art joint connector.

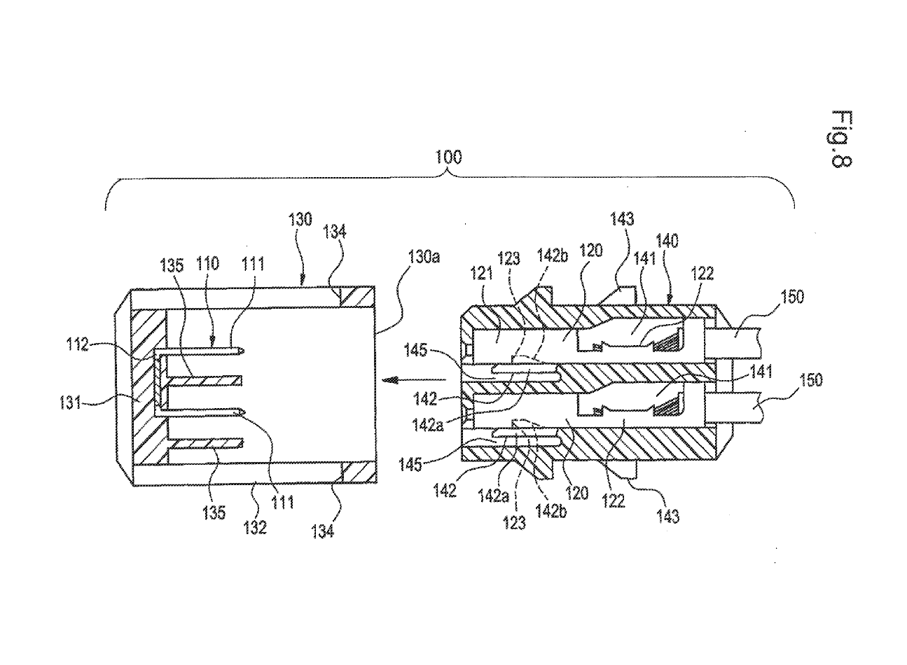

### EMBODIMENT FOR IMPLEMENTING THE PRESENT INVENTION

A preferred embodiment of a joint connector unit of the present invention is hereunder described in detail by reference to the drawings.

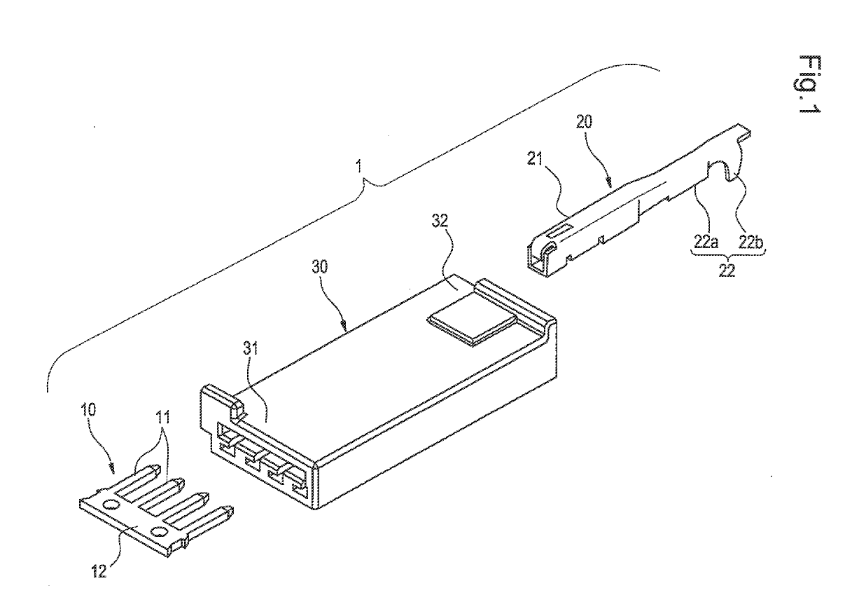

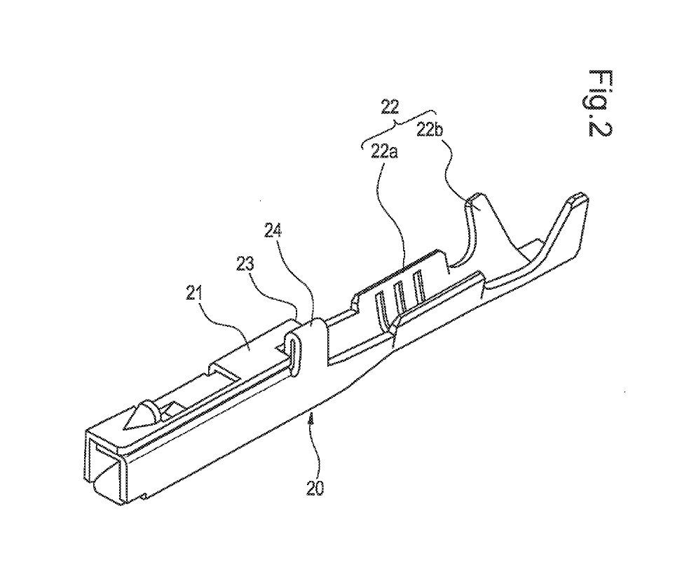

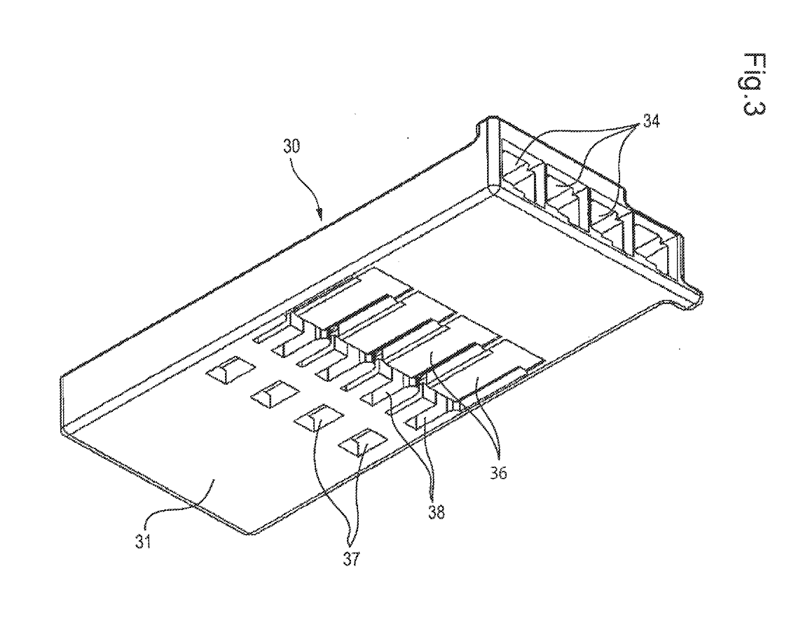

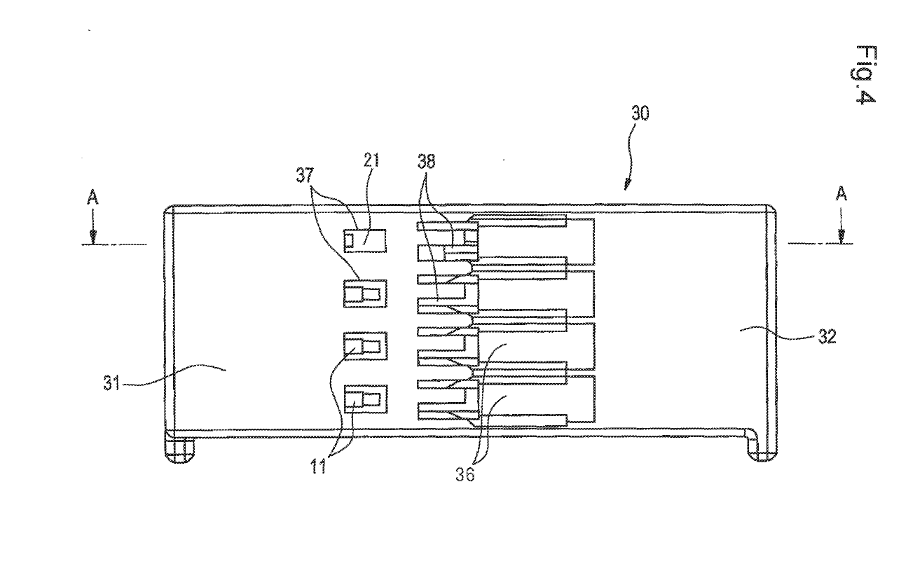

FIG. 1 to FIG. 4 show an embodiment of the joint connector unit of the present invention, wherein FIG. 1 is an exploded perspective view of the embodiment of the joint connector unit of the present invention; wherein FIG. 2 is a perspective view of a leading end of female terminal fittings shown in FIG. 1 acquired when it is viewed from a diagonally upper right position; wherein FIG. 3 is a perspective view of another end of a connector housing shown in FIG. 1 acquired when it is viewed from a diagonally lower left position; and wherein FIG. 4 is a bottom view of the connector housing shown in FIG. 1.

As shown in FIG. 1, a joint connector 1 of the embodiment is equipped with a joint terminal 10, pieces of female terminal fittings 20, and a plastic connector housing 30.

The joint terminal 10 has a plurality of tab pieces 11 that are articles formed from a metal plate by pressing and are to be fit-connected to the respective pieces of female terminal fittings 20 and a joining section 12 that conductively interconnects the tab pieces 11.

As shown in FIG. 1 and FIG. 2, each of the pieces of female terminal fittings 20 has a rectangular-tube-like box section 21 that is an article formed from a metal plate by pressing and into which the corresponding tab piece 11 is to be fitted, a cable caulking section 22 that stretches out of a rear end of each of the box sections 21 and that crimps an electric cable, an engagement recess 23 for retaining purpose, and an insert guide projection 24,

The cable caulking section 22 has a conductor caulking piece 22a that crimps a conductor of the electric cable and a sheath caulking piece 22b that is caulked to a sheath of the electric cable, thereby fastening the electric cable.

In the embodiment, the engagement recess 23 for retaining purpose is an indentation formed at a rear end of the box section 21.

The insert guide projection 24 is a tongue-shaped piece that is situated at a position closer to a rear end of the box section 21 and that stretches along a direction in which the insert guide projection 24 is inserted into a corresponding female terminal accommodation hole of the connector housing 30 to be described later. The insert guide projection 24 is formed into a shape of a tongue by stretching a portion of a sidewall of the box section 21 and bending the thus-stretched portion.

The connector housing 30 has a one housing end part 31 that is an article formed from a resin by injection molding and another housing end part 32 that is on the other side of the one housing end part 31.

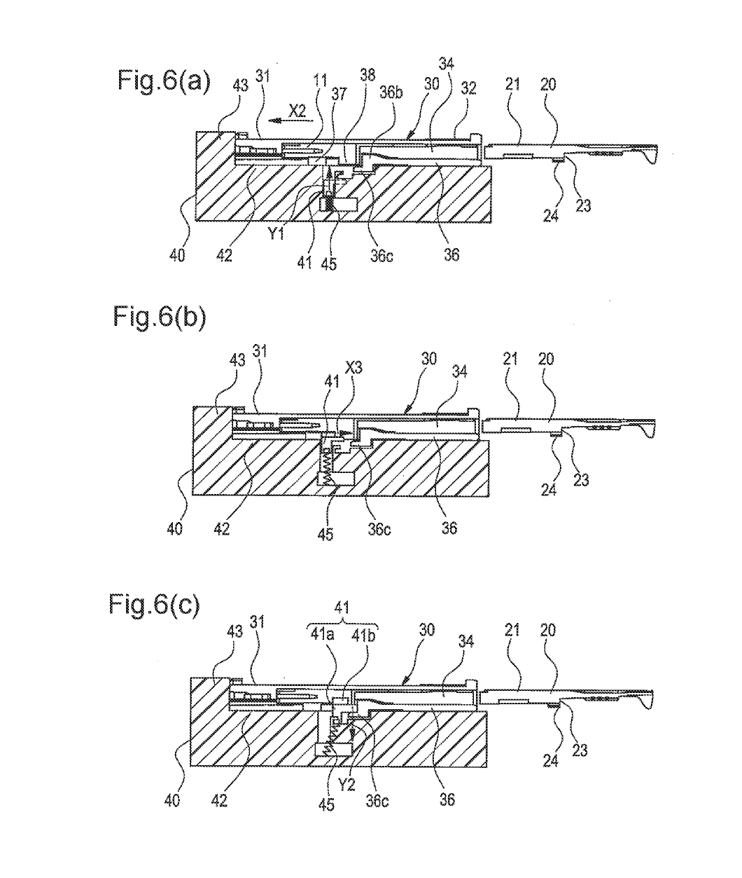

As shown in FIG. 6, the one housing end part 31 accommodates and retains the joint terminal 10 while the tab pieces 11 are oriented toward the other housing end part 32.

As shown in FIG. 3 to FIG. 5, a plurality of female terminal accommodation holes 34 are arranged at the other housing end part 32. The plurality of female terminal accommodation holes 34 are holes that fit the tab pieces 11 into the corresponding pieces of female terminal fittings 20 as a result of the female terminal fittings 20 being inserted up to a specified position. The expression “specified position” means a location where a contact length which is necessary and sufficient to establish an electrical connection between the tab pieces 11 and the box section 21 is achieved.

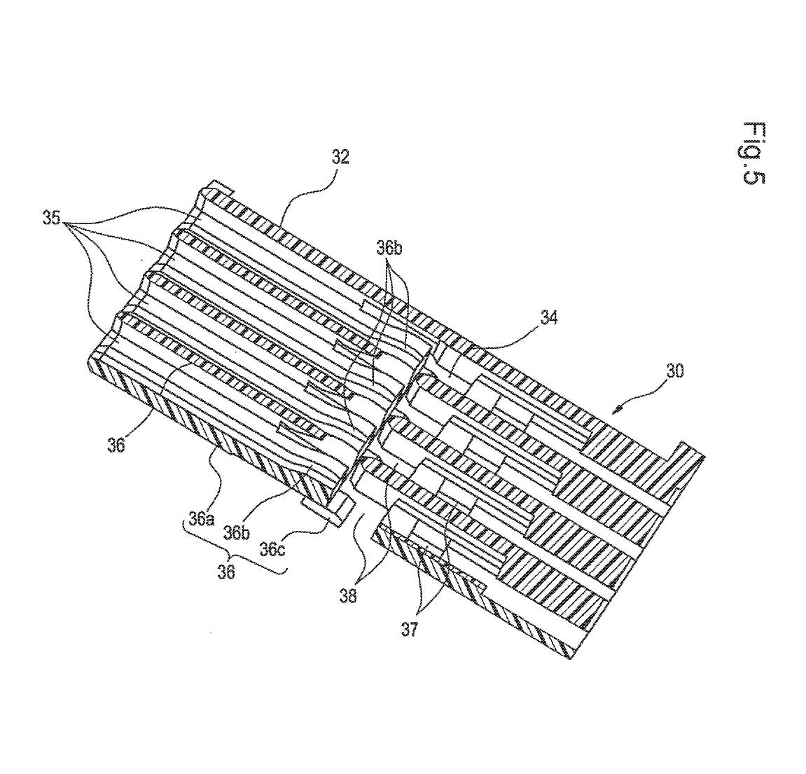

As shown in FIG. 5, each of the female terminal accommodation holes 34 is provided with a guide groove 35.

When the pieces of female terminal fittings 20 are inserted into the respective female terminal accommodation holes 34, the guide grooves 35 accommodate the insert guide projections 24 in a slidable manner and guide the female terminal fittings 20 to the specified position,

In the case of the embodiment, as shown in FIG. 3 to FIG. 6(c), a lance 36, a tab visual-observation window 37, and a jig insert hole 38 are provided in a lower wall surface of the connector housing 30 and in correspondence to a location of each of the female terminal accommodation holes 34 so as to establish a mutual communication with the corresponding female terminal accommodation hole 34.

As shown in FIG. 5 to FIG. 6(c), each of the lances 36 has a resilient piece 36a that stretches along the corresponding female terminal accommodation hole 34, a terminal latching projection 36b projectingly provided at a free end (a right end in FIG. 5) of the resilient piece 36a, and a jig joint projection 36c.

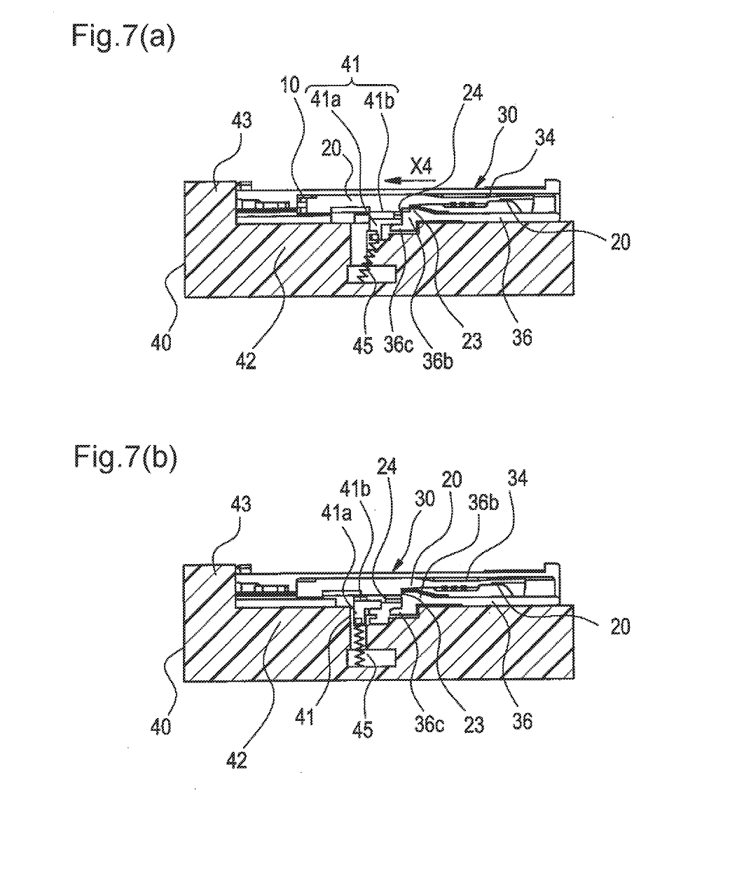

The terminal latching projection 36b projects toward the female terminal accommodation hole 34 and comes into engagement with the engagement recess 23 of the corresponding female terminal fittings 20 inserted up to the specified position as shown in FIG. 7(h), thereby retaining the female terminal fittings 20.

As shown in FIG. 5 to FIG. 6(c), the jig joint projections 36c are provided at free ends of the respective lances 36 in the form of a lug which projects toward corresponding tab pieces 11. The jig joint projections 36c are areas with which respective terminal attachment jigs 41 to be described later are to come into engagement.

As shown in FIG. 4, a tab visual-observation window 37 is opened at a position where a leading end of the tab piece 11 can be visually observed and enables visual observation of the box section 21 fitted to the tab piece 11.

The jig insert hole 38 is an opening used for inserting the terminal attachment jig 41 of a connector assembly apparatus 40 shown in FIG. 6(a) to FIG. 7(b). The jig insert hole 38 is formed in an exterior wall of the housing in the form of a through hole such that the free end of the lance 36 including the jig joint projection 36c and an edge of the free end are laid bare on the exterior surface.

Before the pieces of female terminal fittings 20 are attached to the respective female terminal accommodation holes 34 of the connector housing 30, the connector housing 30 is assembled to the connector assembly apparatus 40 as shown in FIG. 6(a) to FIG. 7(b).

As shown in FIG. 6(a) to FIG. 7(b), the connector assembly apparatus 40 has a base part 42 on which a lower wall surface of the connector housing 30 with the jig insert holes 38 is to be rested, an end contact part 43 that contacts one end face of the connector housing 30 rested on the base part 42, thereby regulating movement of the connector housing 30 in a direction of insertion of the female terminal fittings 20 (i.e., a direction of arrow X2 of FIG. 6(a)), and the terminal attachment jig 41 to be inserted into the respective jig insert holes 38.

As shown in FIG. 6(a) to FIG. 6(c), the terminal attachment jig 41 is incorporated in the base part 42.

The terminal attachment jig 41 incorporated in the base part 42 is supported so as to be movable in a vertical direction designated by arrows Y1 and Y2 and in a direction of engagement of a terminal designated by arrow X3 in FIG. 6(a) to FIG. 6(c).

As shown in FIG. 6(c), the terminal attachment jig 41 has hook-shaped jig bodies 41a to be caught by the respective jig joint projections 36c and disengagement recess 41b that are formed, like a bossing, on the respective jig bodies 41a.

When the connector housing 30 is positioned on the base part 42 and the end contact part 43 as shown in FIG. 6(a), the terminal attachment jig 41 is pulled up in direction of arrow Y1 (an upward direction in FIG. 6(a)) by un-illustrated elevation means against pull strength of a spring 45, inserted into the jig insert holes 38 as shown in FIG. 6(b), and positioned at a height at which leading ends of the respective hook-shaped jig bodies 41a can engage with the respective jig joint projections 36c.

The terminal attachment jig 41 positioned at a height at which it can engage with the respective jig joint projections 36c is slid in direction of arrow X3 shown in FIG. 6(b) by un-illustrated movement operation means. As shown in FIG. 6(c), the jig bodies 41a latch on the jig joint projections 36c, respectively. Moreover, the terminal attachment jig 41 that latches on the respective jig joint projections 36c is forced in a direction designated by arrow Y2 in FIG. 6(c). Forcing action oriented in the direction of arrow Y2 is effected by pull strength of the spring 45 or un-illustrated forcing means.

By dint of the strength exerted in the direction of arrow Y2 shown in FIG. 6(c), the free end of each of the lances 36 becomes deflected and deformed in a direction away from the corresponding female terminal accommodation hole 34 as shown in FIG. 7(a). As a result of the lance 36 becoming deflected and deformed in the direction away from the female terminal accommodation hole 34, the terminal latching projection 36b of the lance 36 is lowered to a position where it does not interfere with the corresponding piece of female terminal fittings 20 to be inserted into the female terminal accommodation hole 34 or a position where the interference is significantly abated.

For these reasons, when the pieces of female terminal fittings 20 are inserted into the respective female terminal accommodation holes 34, the pieces of female terminal fittings 20 do not go through interference, which would otherwise occur when the female terminal fittings 20 contacts the respective lances 36. Thus, actuating strength required during insertion of the female terminal fittings 20 is lessened, which facilitates attachment of the female terminal fittings 20. Arrow X4 shown in FIG. 7(a) designates a direction of insertion of the female terminal fittings 20.

In the case of the embodiment, when the female terminal fittings 20 have reached the specified position, the insert guide projections 24 that make up upper parts of the pieces of female terminal fittings 20 collide against the disengagement recess 41b on the respective terminal attachment jig 41. Thereupon, as shown in FIG. 7(b), the terminal attachment jig 41 is unlatched from the respective lances 36 by the interference between the insert guide projections 24 and the disengagement recess 41b. Further, as shown in FIG. 7(b), the terminal attachment jig 41 unlatched from the lances 36 restores itself to its initial state in which it is embedded in the base part 42, by dint of the pull strength of the spring 45.

Specifically, in the case of the embodiment, when the terminal attachment jig 41 is attached to the connector housing 30 before insertion of the female terminal fittings 20, the jig bodies 41a to be inserted into the respective jig insert holes 38 latch on the free ends of the respective lances 36, thereby deforming and deflecting the respective lances 36 such that the terminal latching projections 36b of the respective lances 36 move away from the corresponding female terminal accommodation holes 34. In addition, when the female terminal fittings 20 have reached the specified position, the jig bodies 41a of the terminal attachment jig 41 are unlatched from the respective lances 36 by interference between parts (the insert guide projections 24) on the respective pieces of female terminal fittings 20 and the terminal attachment jig 41, whereby the lances 36 are returned to a state where they retain the respective pieces of female terminal fittings 20.

In the embodiment, when the female terminal fittings 20 has reached the specified position in the respective female terminal accommodation holes 34, the insert guide projections 24 on the female terminal fittings 20 that slide along the guide grooves 35 of the connector housing 30 during insertion of the female terminal fittings 20 into the female terminal accommodation holes 34 collide against the terminal attachment jig 41, thereby acting also as unlatching means for unlatching the terminal attachment jig 41 from the respective lances 36.

In the configuration of the joint connector 1 of the embodiment that has been described thus far, a fit connection between the joint terminal 10 and the female terminal fittings 20 is implemented by means of the single connector housing 30 that accommodates and retains at one end the joint terminal 10 and that receives at the other end the female terminal fittings 20 being inserted. Therefore, when compared with the related art joint connector made by fit-connection of a pair of connector housings, the number of components can be curtailed.

Retaining the female terminal fittings 20 in the connector housing 30 is realized by means of the engagement between the lances 36 provided in the connector housing 30 and the engagement recesses 23 of the female terminal fittings 20. However, in the course of the pieces of female terminal fittings 20 being inserted into the respective female terminal accommodation holes 34, the lances 36 are moved away from the female terminal accommodation holes 34 by the terminal attachment jig 41.

Accordingly, during the female terminal fittings 20 being inserted into the connector housing 30, the female terminal fittings 20 does not undergo resistance from the lances 36. Hence, operation for inserting the female terminal fittings 20 is facilitated, so that ease of assembly can be enhanced.

Furthermore, in the configuration of the joint connector 1 of the embodiment that has been described so far, when the female terminal fittings 20 is inserted up to the specified position in the respective female terminal accommodation holes 34 as shown in FIG. 7(a) and FIG. 7(b) while the terminal attachment jig 41 remains fitted to the connector housing 30 as shown in FIG. 6(a) to FIG. 6(c), the insert guide projections 24 outfitted to the respective pieces of female terminal fittings 20 collide against the terminal attachment jig 41, thereby bringing the terminal attachment jig 41 out of engagement with the lances 36.

Put another way, the jig bodies 41a of the terminal attachment jig 41 outfitted to the connector housing 30 is held in engagement with the respective lances 36 until the female terminal fittings 20 reaches the specified position in the respective female terminal accommodation holes 34. Therefore, it is possible to detect whether or not the female terminal fittings 20 outfitted to the connector housing 30 is in a half-fitted state according to whether or not the terminal attachment jig 41 is disengaged from the lances 36. Accordingly, a necessity for outfitting a custom-designed half-fitted slate detection structure to the connector housing 30 is obviated, and hence the structure of the connector housing 30 can be simplified.

Incidentally, the joint connector unit of the present invention is not restricted to the embodiment and susceptible to alterations and modification, as required.

For instance, in a connector assembly apparatus, an electric actuation mechanism utilizing a motor or a solenoid as well as an appropriate mechanism entailing manual operation can also be utilized for the means for moving the terminal attachment jig in the direction of arrow X3 in FIG. 6(b).

Moreover, a variety of known actuation mechanisms can also be utilized also for a mechanism which vertically actuates the terminal attachment jig forward and backward.

Although the present invention has been described in detail by reference to the specific embodiment, it is manifest to those who are versed in the art that the present invention be susceptible to various alterations or modifications without departing the spirit and scope of the present invention.

The patent application is based on Japanese Patent Application (JP-2011-030099) filed on Feb. 15, 2011, the subject matter of which is incorporated herein by reference in its entirety.

### INDUSTRIAL APPLICABILITY

In the joint connector unit of the present invention, a fit connection between the joint terminal and the female terminal fitting is implemented by means of the single connector housing that accommodates and retains at one end the joint terminal and that receives at the other end the female terminal fitting being inserted. Therefore, when compared with the related art joint connector made by fit-connection of a pair of connector housings, the number of components can he curtailed.

### DESCRIPTIONS OF REFERENCE NUMERALS AND SYMBOLS

1 JOINT CONNECTOR

10 JOINT TERMINAL

11 TAB PIECE

20 FEMALE TERMINAL FITTING

21 BOX SECTION

24 INSERT GUIDE PROJECTION (PART)

30 CONNECTOR HOUSING

31 ONE HOUSING END PART

32 ANOTHER HOUSING END PART

34 FEMALE TERMINAL ACCOMMODATION HOLE

35 GUIDE GROOVE

36 LANCE

36b TERMINAL LATCHING PROJECTION

36c JIG JOINT PROJECTION

37 TAB VISUAL-OBSERVATION WINDOW

38 JIG INSERT HOLE

40 CONNECTOR ASSEMBLY APPARATUS

41 TERMINAL ATTACHMENT JIG

41a JIG BODY

41b DISENGAGEMENT RECESS

42 BASE PART

43 END CONTACT PART

45 SPRING

1. A joint connector unit comprising:
a plurality of pieces of female terminal fittings;
a joint terminal having a plurality of tab pieces for fit-connecting the pieces of female terminal fittings and a joining section for conductively connecting the tab pieces;
a plastic connector housing having one housing end part that accommodates and retains the joint terminal such that the tab pieces are oriented toward an other housing end part, the other hosing end that has arrayed female terminal accommodation holes for fitting the tab pieces into respective pieces of the female terminal fittings as a result of the pieces of female terminal fittings being inserted up to a specified position;
a lance that has resilient pieces stretching along the female terminal accommodation holes and a terminal latching projection projecting from free ends of the respective resilient pieces toward the corresponding female terminal accommodation holes, the lance retaining the pieces of female terminal fittings inserted to the specified position by the terminal latching projections;
a plurality of jig insert holes penetratingly opened in an exterior housing wall such that free ends of the respective lances are externally laid open; and
a terminal attachment jig that causes jig bodies inserted into the respective jig insert holes to latch on the free ends of the respective lances when attached to the connector housing before insertion of the female terminal fittings and that deflects and deforms the lances such that the terminal latching projections move away from the respective female terminal accommodation holes and that unlatches the jig bodies from the lances by interference between parts on the respective pieces of female terminal fittings and the terminal attachment jig when the respective pieces of female terminal fittings have reached the specified position, so as to return the lances to a state where the lances retain the female terminal fittings.

2. The joint connector unit according to claim 1, wherein the respective pieces of female terminal fittings have insert guide projections that stretch along a direction of insertion into the respective female terminal accommodation holes;
the connector housing has guide grooves that slidably accommodate the insert guide projections during insertion of the pieces of female terminal fittings into the female terminal accommodation holes, so as to guide the pieces of female terminal fittings to the specified position; and
the insert guide projections collide against the jig bodies when the pieces of female terminal fittings have reached the specified position, thereby unlatching the jig bodies from the lances.
